(19) United States
(12) Patent Application Publication
(10) Pub. No.: US 2011/0284302 A1
(43) Pub. Date: Nov. 24, 2011

(54) BICYCLE FRAME, BICYCLE HAVING THE SAME AND ELECTRIC BICYCLE HAVING THE SAME

(76) Inventor: YI-LIN CHIU, Taichung City (TW)

(21) Appl. No.: 12/782,698

(22) Filed: May 18, 2010

(51) Int. Cl. B62K 3/10; B62K 11/06

(52) U.S. Cl. 180/220; 280/281.1

(57) ABSTRACT

A bicycle frame includes a transversal tube, a front tube, a seat tube, a bottom bracket assembly and a chain stay assembly. The transversal tube has a front portion, an angle portion, a connecting portion and an extension portion. The angle portion is curved and connects the rear end of the front portion and the connecting portion so that the front portion is not parallel to the connecting portion. The extension portion is extended rearward from the connecting portion. A receiving space is defined in the connecting portion and the extension portion, and the receiving space is longitudinal. A joint position is defined between the connecting portion and the extension portion. The front tube is disposed on the front end of the front portion. The seat tube is disposed on the joint position. The bottom bracket assembly and the chain stay assembly are both disposed on the transversal tube.

### BACKGROUND OF THE INVENTION

1. Field of the Invention

The present invention relates to a bicycle frame, a bicycle and an electric bicycle having the bicycle frame.

2. Description of the Prior Art

As disclosed in TW 399600, a conventional bicycle frame for electronic bicycle is designed to have a collapsible tube and a battery installed in that collapsible tube. It is noted that a collapsible tube is usually weak in mechanical strength, and the cost thereof is high.

The present invention is, therefore, arisen to obviate or at least mitigate the above mentioned disadvantages.

### SUMMARY OF THE INVENTION

The main object of the present invention is to provide a non-collapsible bicycle frame adapted for a battery to install therein.

To achieve the above and other objects, the bicycle frame of the present invention has a front and a rear, and further includes a transversal tube, a front tube, a seat tube, a bottom bracket assembly and a chain stay assembly. The transversal tube extends from the front to the rear of the bicycle frame, and the transversal tube has a front portion, an angle portion, a connecting portion and an extension portion. The front portion has a front end and a rear end. The angle portion is curved and connects the rear end of the front portion and the connecting portion so that the front portion is not parallel to the connecting portion. The extension portion is extended rearward from the connecting portion. A receiving space is defined in the connecting portion and the extension portion, and the receiving space is longitudinal. A joint position is defined between the connecting portion and the extension portion. The front tube is disposed on the front end of the front portion. The seat tube is disposed on the joint position of the transversal tube. The bottom bracket assembly is disposed on the transversal tube and is located beneath the connecting portion. The chain stay assembly is disposed on the transversal tube.

Thereby, the receiving space is adapted to receive a battery therein, and thus the bicycle frame is adapted for an electric bicycle.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective drawing showing an electric bicycle of the present invention;

FIG. 2 is a side view showing a bicycle frame of the present invention;

FIG. 3 is a breakdown drawing showing an electric bicycle of the present invention;

FIG. 4 is a profile showing an electric bicycle of the present invention.

### DETAILED DESCRIPTION OF THE PREFERRED EMBODIMENTS

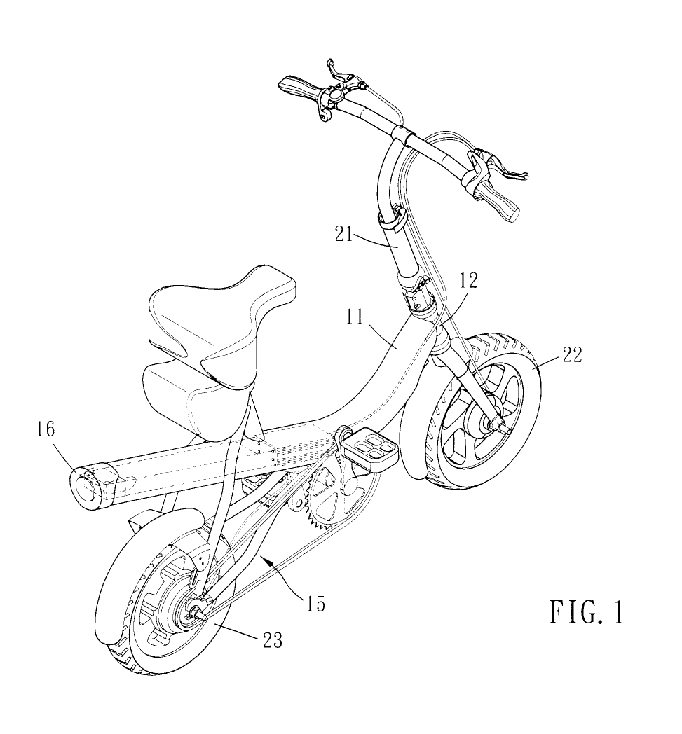

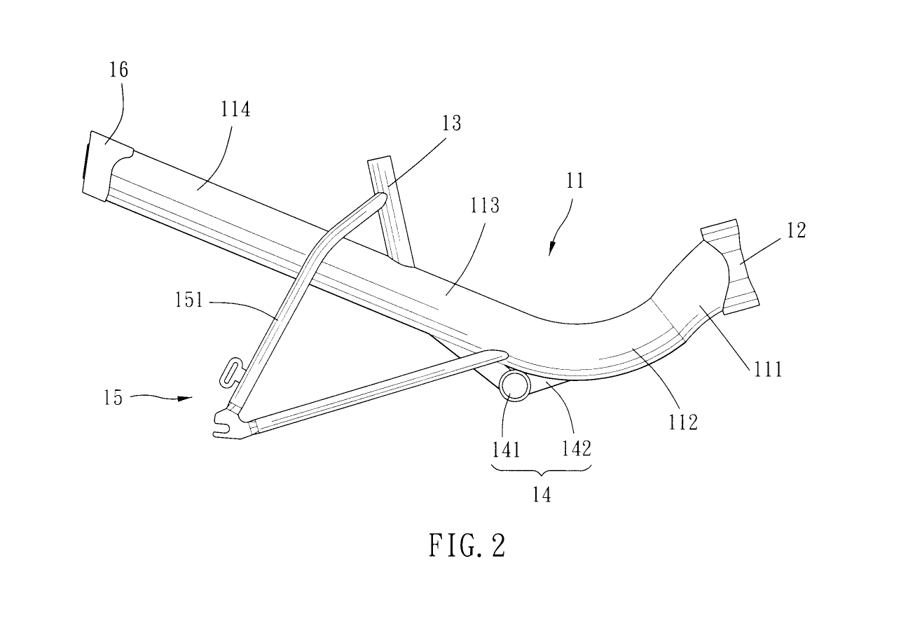

Please refer to FIG. 1. A bicycle frame of the present invention is adapted for a bicycle, especially for an electric bicycle. Please refer to FIG. 2. The bicycle has a front and a rear, and includes a transversal tube 11, a front tube 12, a seat tube 13, a bottom bracket assembly 14, a chain stay assembly 15 and an end cap 16.

The transversal tube 11 extends from the front to the rear of the bicycle frame, and the transversal tube 11 includes a front portion 111, an angle portion 112, a connecting portion 113 and an extension portion 114. Further, the transversal tube 11 is hollow. The front portion 111 has a front end and a rear end. The angle portion 112 is curved and connects the rear end of the front portion 111 and the connecting portion 113 so that the front portion 111 is not parallel to the connecting portion 113. The extension portion 114 is extended rearward from the connecting portion 113. The outer surfaces of the connecting portion 113 and extension portion 114 can flush to each other. Yet in other possible embodiments of the present invention, the outer surfaces thereof may also be wavy, curve or have grooves thereon. A receiving space is defined in the connecting portion 113 and the extension portion 114, and the receiving space is longitudinal and has an open end at the distal end of the extension portion 114. More specifically, the distal end of the extension portion 114 defines an opening communicating the receiving space. Such receiving space comes in very useful when the rider needs to carry elongated objects, such as an umbrella, a baseball bat or bicycle repair kits. Preferably, the extension portion 114 is slanted, and the distal end thereof is the highest position. The end cap 16 is adapted to cap on the distal end of the extension portion 114 so as to enclose the receiving space. Further, the end cap 16 has an outer surface facing rearward, and a reflector and/or a brake light can disposed on the outer surface of the end cap 16.

The front tube 12 is disposed on the front end of the front portion 111. Specifically, the front tube 12 defines an axis, which is vertical or slightly slanted to the vertical direction. The seat tube 13 is disposed on the joint position, which is defined between the connecting portion 113 and the extension portion 114, of the transversal tube. More specifically, the seat tube 13 has a lower end fixedly disposed on the joint position, and the rest part of the scat tube 13 substantially extends upward. In the present embodiment, the bottom bracket assembly 14 includes a bottom bracket 141 and two connecting tubes 142, each of which connects between the bracket 141 and the transversal tube. Thus the bottom bracket assembly 14 locates beneath the connecting portion 113. In other possible embodiments of the present invention, the bottom bracket assembly may consist of the bottom bracket 141 only, and the bottom bracket is directly disposed a bottom of the transversal tube 11. The chain stay assembly 15 may consists of several tubes 151, which connect to the transversal tube 11 and the scat tube 13 respectively. In other possible embodiments of the present invention, the tubes 151 may connect to the seat tube 13 and the bottom bracket assembly 14 but not directly connect to the transversal tube 11. Since the transversal tube is the critical component to bear the rider's weight, it is designed to have the largest outer diameter. That is, the outer diameter of the transversal tube 11 is larger than that of any of the front tube, the seat tube and the chain stay assembly.

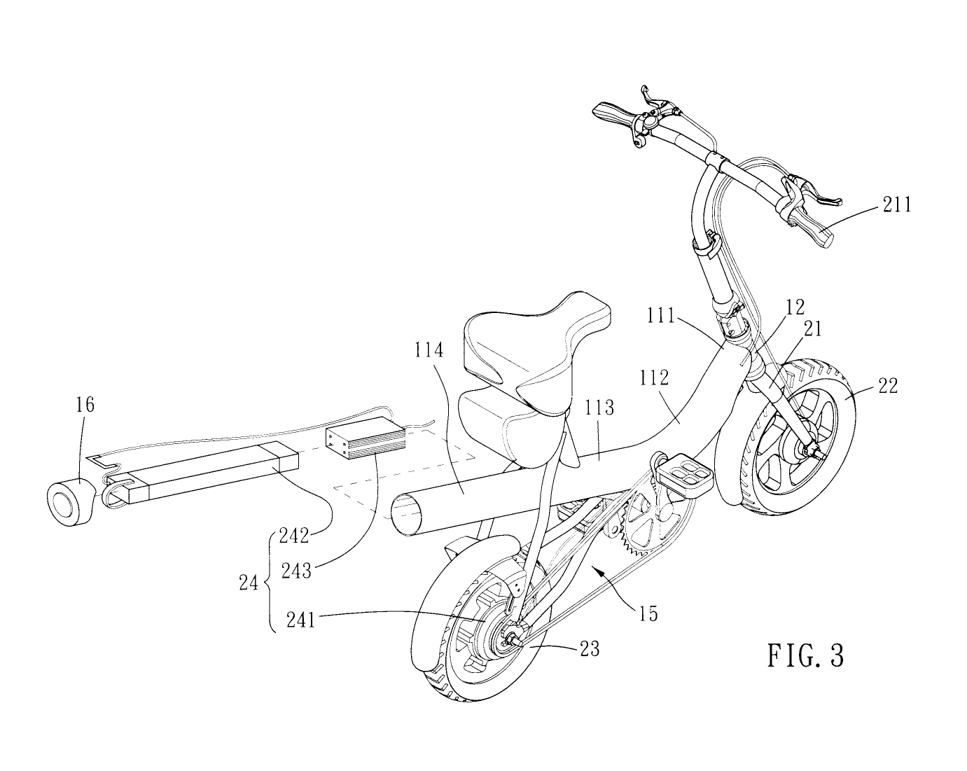

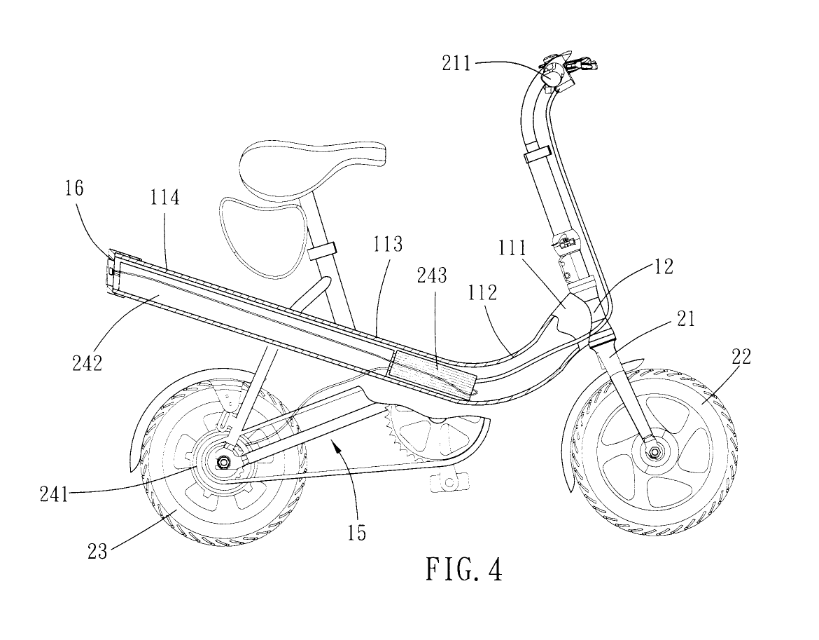

Please refer to FIG. 3 and FIG. 4. The electric bicycle includes a bicycle frame as discussed hereinabove, and further includes a front fork assembly 21, a front wheel 22, a rear wheel 23 and a power device 24. The front fork assembly 21 is rotatably disposed on the front tube 12. More specifically, the front fork assembly 21 includes a stem rotatably received in the front tube 12, two front fork members and a handle 21 disposed atop the stem. The front wheel 22 is rotatably disposed on the front fork assembly 21. More specifically, the front wheel 22 is supported by the front fork members. The rear wheel 23 is rotatably disposed on the chain stay assembly 15. The power device 24 includes a motor 241, a battery 242 and a control circuit element 243. The motor 241 is disposed on the rear wheel to drive the rear wheel to rotate. In other possible embodiments of the present invention, the motor 241 may connects to the front wheel instead. The battery 242 is disposed in the receiving space. The control circuit element 243 can also be received in the receiving space. Further, the control circuit element 243 electrically connects the battery 242 to the motor 241 and controls the function of the motor 241. More specifically, the control circuit element 243 includes a trigger sleeve disposed about the handle 211. As the rider turns the trigger sleeve, the motor 241 can be activated to drive the electric bicycle forward. In other possible embodiments of the present invention, the control circuit element 243 may be disposed on the transversal tube.

What is claimed is:

1. A bicycle frame, having a front and a rear, comprising
a transversal tube, extending from the front to the rear of the bicycle frame, the transversal tube having a front portion, an angle portion, a connecting portion and an extension portion, the front portion having a front end and a rear end, the angle portion being curved and connecting the rear end of the front portion and the connecting portion so that the front portion being not parallel to the connecting portion, the extension portion being extended rearward from the connecting portion, a receiving space being defined in the connecting portion and the extension portion, the receiving space being longitudinal, a joint position being defined between the connecting portion and the extension portion;
a front tube, disposed on the front end of the front portion;
a seat tube, disposed on the joint position of the transversal tube;
a bottom bracket assembly, disposed on the transversal tube and located beneath the connecting portion;
a chain stay assembly, disposed on at least on of the transversal tube, seat tube and the bottom bracket assembly.

2. The bicycle frame of claim 1, wherein an outer diameter of the transversal tube is larger than that of any of the front tube, the seat tube and the chain stay assembly.

3. The bicycle frame of claim 1, wherein the extension portion has a distal end, the distal end defines an opening communicating with the receiving space.

4. The bicycle frame of claim 3, further comprising an end cap, disposed on the distal end of the extension portion to enclose the receiving space.

5. A bicycle, having a bicycle frame of claim 1, further comprising
a front fork assembly, rotatably disposed on the front tube;
a front wheel, rotatably disposed on the front fork assembly;
a rear wheel rotatably disposed on the chain stay assembly.

6. An electric bicycle, having a bicycle frame of claim 1, further comprising
a front fork assembly, rotatably disposed on the front tube;
a front wheel, rotatably disposed on the front fork assembly;
a rear wheel rotatably disposed on the chain stay assembly;
a power device, comprising a motor, a battery and a control circuit element, the motor being connected to one of wheels, the motor being adapted to drive one of the wheels to rotate, the battery being disposed in the receiving space, the control circuit element electrically connecting the battery to the motor, the control circuit element controlling the function of the motor.

7. The electric bicycle of claim 6, wherein the control circuit element is also disposed in the receiving space, the control circuit element is closer to the angle portion than the battery.
